(19) United States
(12) Patent Application Publication
(10) Pub. No.: US 2004/0141182 A1
(43) Pub. Date: Jul. 22, 2004

(54) Monitoring of spectral purity and advanced spectral characteristics of a narrow bandwidth excimer laser

(76) Inventors: Thomas Schroder, Goettingen (DE); Holger Bald, Goettingen (DE); Hans-Stephan Albrecht, Goettingen (DE); Thomas Schmidt, Goettingen (DE); Christian Schramm, Bovenden (DE)

Correspondence Address: STALLMAN & POLLOCK LLP, Suite 290, 121 Spear Street, San Francisco, CA, 94105, US

(21) Appl. No.: 10/732,094

(22) Filed: Dec. 10, 2003

Related U.S. Application Data
(60) Provisional application No. 60/434,044, filed on Dec. 16, 2002.

(51) Int. Cl. G01B 9/02

(52) U.S. Cl. 356/454

(57) ABSTRACT

An on-board diagnostic tool can be used to monitor the spectral purity of a lithography laser, such as an excimer or molecular fluorine laser, instead of simply measuring the FWHM bandwidth of the laser. One such on-board tool utilizes a Fabry-Perot Interferometer etalon with a high-finesse and a small free spectral range, which provides the precision necessary to determine spectral purity, while providing the small footprint and light weight necessary to use the tool on-board. A high signal-to-noise detector can be used to improve the accuracy of the measurements.

### CLAIM OF PRIORITY

This patent application claims priority to U.S. provisional patent application No. 60/434,044, entitled “Monitoring of spectral purity and advanced spectral characteristics of a narrow bandwidth excimer laser,” filed Dec. 16, 2002, which is hereby incorporated herein by reference.

### CROSS-REFERENCE TO RELATED APPLICATIONS

The following applications are cross-referenced and hereby incorporated herein by reference:

U.S. patent application Ser. No. 10/293,906, entitled “HIGH-RESOLUTION CONFOCAL FABRY-PEROT INTERFEROMETER FOR ABSOLUTE SPECTRAL PARAMETER DETECTION OF EXCIMER LASER USED IN LITHOGRAPHY APPLICATIONS,” to Peter Lokai, filed Aug. 28, 2003; and

U.S. patent application Ser. No. 10/103,531, entitled “COMPACT HIGH RESOLUTION SPECTROMETER FOR LITHOGRAPHY LASERS,” to J. Kleinschmidt, filed Aug. 6, 2003.

### TECHNICAL FIELD OF THE INVENTION

The present invention relates to on-line spectrometers useful for industrial applications of gas discharge lasers, such as excimer and molecular fluorine lasers.

### BACKGROUND

Line narrowed excimer lasers are used with various photolithography systems in the production of integrated circuits. The use of line narrowed excimer lasers minimizes errors that could otherwise be caused by chromatic aberrations in the system, as achromatic imaging optics for this wavelength region have proven to be expensive and difficult to produce. As design requirements for integrated circuits continue to push the limits of existing photolithography systems, there is a need for exposure radiation sources capable of supporting high numerical aperture lithographic optical imaging systems. These radiation sources will need to have laser radiation bandwidths of less than about 0.5 pm, and spectral purities of less than about 1 pm. The spectral purity shall be referred to herein as “E95,” as the spectral purity is defined as the wavelength interval containing 95% of the pulse energy. The spectral bandwidth of the laser is typically measured at 50% of the peak intensity, referred to herein as the full width at half maximum (FWHM) value, as is known in the art. Spectral purity can be used to determine the line shape of a spectrum.

For existing microlithography applications, it is very important that the laser is always operating within the necessary specifications in order to avoid yield problems during chip production. When the laser is operating outside the necessary specifications, the spectral broadening can lead to the blurring of integrated circuits being printed on silicon wafers. Any variation in bandwidth can have a strong influence on the microlithography printing process. Variations in bandwidth can be caused by the laser gas itself, as a specific concentration, combination, and/or purity of the gas can be needed for the laser to operate within specification. The laser gas therefore needs to be changed and/or replenished periodically in order to maintain these requirements. Variations in bandwidth also can be caused by other factors, such as thermal effects on the system optics and/or misalignment of the laser resonator. Because these variations can have drastic and detrimental effects on the photolithography process, and the production of integrated circuits in specific applications, it can be critical to be able to monitor and/or control the spectral characteristics.

Existing spectrometers that can be used to determine FWHM and/or E95 spectral purity typically are relatively large in size, such as a model ELIAS spectrometer manufactured by Laser Technik Berlin of Berlin, Germany. The size of such spectrometers can prevent use of the spectrometers as on-board metrology tools for lithographic system use. As such, a large spectrometer can be used to measure the E95 of a laser before the laser is shipped from the factory. This value of E95 is then used throughout the life of the laser to provide “more accurate” spectral characterization when measuring FWHM. Smaller spectrometers can be used, such as a grating spectrometer as described in U.S. Pat. No. 6,061,129, incorporated herein by reference above. The smaller design is enabled by the use of prism beam expanding optics in place of reflective optics. Such a device, however, is not optimal for lithography applications. Other relatively small spectrometers are used to measure FWHM during laser operation, but also are not able to sufficiently measure E95 variations. Still other systems utilize Fabry-Perot-Interferometers (FPI) configured in a double pass arrangement, such as that described in U.S. patent application Ser. No. 10/293,906, which is assigned to the same assignee as the present application and is incorporated herein by reference above. A problem with a double pass etalon arrangement for lithographic applications, however, is the presence of a low transmission finesse. None of these existing systems is able to determine E95 on-board during operation of the laser, leading to a less-than-optimal spectral characterization.

### BRIEF DESCRIPTION OF THE DRAWINGS

FIG. 1 is a diagram of a system for in-coupling laser light into a grating spectrometer in accordance with one embodiment of the present invention.

FIG. 2 is a diagram of an on-board monitor module (MOM) arrangement in accordance with one embodiment, utilizing (a) a scattering element and (b) a beam homogenizer.

FIG. 3 is a diagram and associated plot for detecting a fringe pattern with a line scan camera in accordance with one embodiment.

FIG. 4 is a plot showing fringe patterns for systems utilizing etalons with a finesse of 15 and 40 in accordance with one embodiment.

FIG. 5 is a plot of spectral purity (E95) calculated from a measured fringe pattern in accordance with one embodiment.

FIG. 6 is a plot showing the spectral purity values calculated by applying an integration range of ±5 pm and ±1 pm in accordance with one embodiment.

FIG. 7 is a plot of a fringe pattern demonstrating a calculation method of E95 in accordance with one embodiment.

FIG. 8 is a plot of bandwidth and spectral purity (E95) measured in a shift test over ±10 pm, depicted over center pixel position, in accordance with one embodiment.

FIG. 9 is a plot of (a) the deviation between external and internal measured bandwidth over 1 billion pulses, and (b) the deviation between external and internal measured E95 over 1 billion pulses, in accordance with one embodiment.

FIG. 10 is a diagram of an excimer or molecular fluorine laser system that can be used in accordance with one embodiment of the present invention.

### DETAILED DESCRIPTION

Systems and methods in accordance with various embodiments of the present invention can provide for an on-board determination of spectral purity (E95) along with the FWHM characteristics of a gas discharge laser system, such as an excimer or molecular fluorine laser system that can be used in applications such as lithography and photolithography applications. The on-board determination can be obtained utilizing a spectrometer system that is light and compact enough to be used on-line with a laser of the photolithography system, yet has the necessary precision to determine fluctuations in spectral purity. The determination of spectral purity along with FWHM in accordance with various embodiments allows for easy detection of variations in the laser light that can have detrimental effects on the photolithography processes. In such embodiments a Fabry Perot etalon can be used, having a high finesse and small free spectral range (FSR<10 pm). Such an etalon can deliver a fringe pattern of narrow bandwidth laser radiation having a high signal to noise ratio, and is small enough to be built as a part of the internal laser diagnostic set. Testing of such systems shows that the relative error of the E95 measurements is smaller than the relative error of the bandwidth data (FW M). When taking into account the fact that a grating spectrometer can have an error of about 0.05 pm for E95 determination, the total error of the on-board E95 measurement can be estimated within a range of about ±0.1 pm. Such accuracy allows the spectral features of the laser to be monitored on-board with high reliability. The on-board components can be included in the laser housing, such as inside a diagnostic module of the laser. Appropriate beam-directing components can be used to direct a portion of the laser output to the on-board components. An improved high-resolution monitor module can be used, as well as improved evaluation software.

Spectral characterization of pulses from a gas discharge laser, such as an excimer or molecular fluorine laser, is typically accomplished by analyzing the pulses using a spectrometer in combination with an angular dispersive element, such as a grating, an etalon, prisms or grisms. The spectral characterization can determine the intensity spectra I(λ), or intensity as a function of wavelength, of the laser pulses. Light characteristics that can be derived from the intensity spectra include the full spectral width at half maximum (FWHM or bandwidth) of the pulses. The FWHM value gives only a very raw characterization of the spectra, as no information is obtained relating to the distribution of spectral intensities with levels below 50%. The E95 parameter can be used with the FWHM value to deliver an integral characterization. A measurement of E95 can provide a better model of spectral behavior than a FWHM measurement.

Existing laser systems only provide for an on-board determination of FWHM, however, as these existing systems do not provide the accuracy or precision needed for useable E95 measurements. In addition to the high spectral resolution needed for FWHM measurements, sufficient E95 measurements can require a large spectral inspection range, a high signal-to-noise ratio, a homogenous measurement background, and accurate background compensation. While existing grating spectrometers with high resolution can be used for a characterization of spectral properties, the relatively large size of these grating spectrometers limits their use to external measurements. Further, the large size of the grating spectrometers does not make them practical for use “in the field.” While on-board spectrometers are used in some systems, these spectrometers only are able to accurately determine the FWHM of the spectra. This is a disadvantage to an on-line diagnostic system, as there is no fixed correlation between FWHM and E95. These on-board spectrometer systems then are limited to measuring E95 during manufacture and/or testing, and are limited to making FWHM measurements in the field.

Systems and methods in accordance with embodiments of the present invention can overcome these and other deficiencies in existing spectral characterization techniques by providing for an on-board determination of E95 spectral purity in gas discharge lasers, such as excimer and molecular fluorine lasers, while still providing accurate FWHM measurements. In these embodiments, a high finesse etalon can be used to determine spectral purity. In order to obtain accurate measurements, an offset of the etalon can be measured during manufacture. The offset of an etalon relative to a grating is stable over time, and subtracting an offset from an etalon value can yield the absolute value of the spectral purity.

A grating spectrometer can be used for such an initial spectral characterization of such a laser. The grating spectrometer is not used on board, due at least in part to the size of the spectrometer. The grating spectrometer can be used to determine an offset to an etalon of the on-board system, as described elsewhere herein. An example of such a spectrometer is the ELIAS I spectrometer, available from LTB Lasertechnik Berlin with headquarters in Berlin, Germany. This spectrometer has an inspection range of about 15 pm (at 193 nm), a pixel resolution of about 15 fm, and a FWHM of the system function of about 0.1 pm. A numeric de-convolution of the measured spectra can be used to eliminate the significant influence of the finite system function. There is a typical difference between measured and de-convoluted laser spectra of about 0.04 pm FWHM and 0.15 pm E95, depending on the spectrometer.

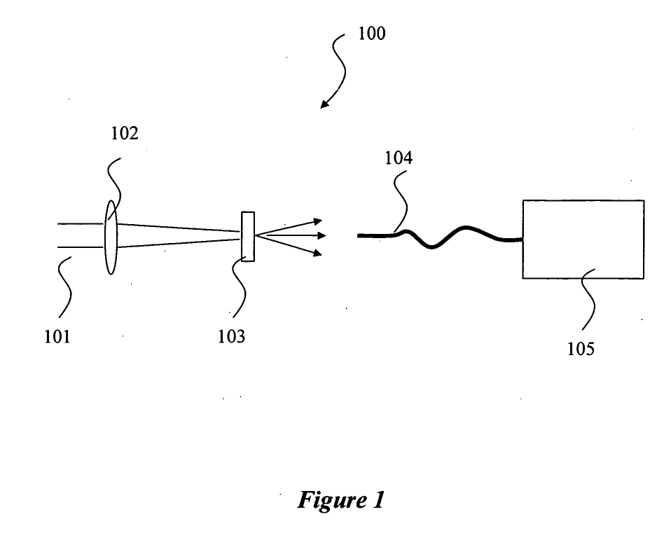

In order to ensure accurate measurement of the laser spectra using such a grating spectrometer, proper in-coupling of the laser light into a small slit of the spectrometer can be necessary. FIG. 1 shows an arrangement 100 providing proper in-coupling in accordance with one embodiment of the present invention. A beam of laser light 101 can be focused by a lens 102, or other appropriate focusing element, to a scattering plate 103, or to another light mixing component such as a diffractive diffuser or lens array, along the beam path. The scattering plate can function to mix the entire beam incident on the scattering plate, regardless of the number of angles incident on the plate. An optical fiber 104 can be placed a distance from the scattering plate that allows the fiber to collect the same portion from all parts and directions of the beam. Such an arrangement should be non-sensitive to typical fluctuations of the laser beam, which can include pointing, position, and energy density distribution. The light that is emitted from fiber can be analyzed by a grating spectrometer 105. This external measurement arrangement can be used to calibrate the on-board measurement system.

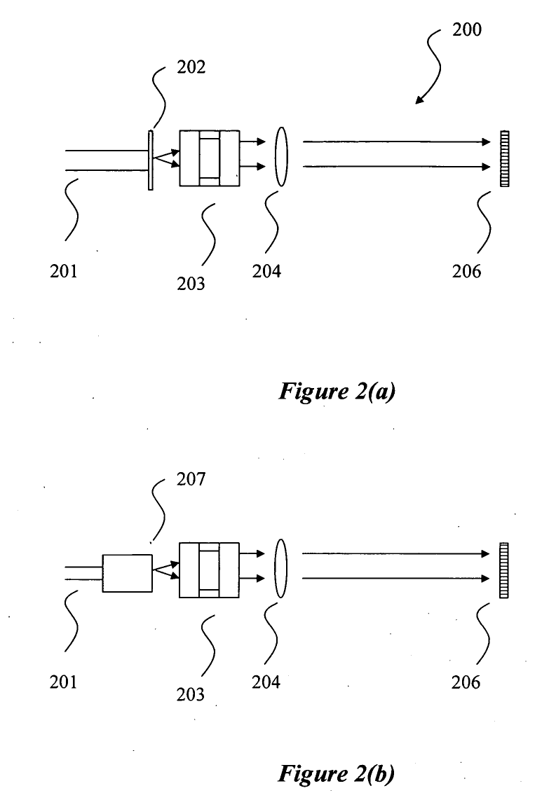

An on-board spectrometry system in accordance with various embodiments can include an on-board monitor module of the laser system. This on-board module can be based on the dispersion of a high finesse etalon, such as a Fabry Perot etalon. FIG. 2(a) shows one possible arrangement 200, wherein a beam of laser light 201 is scattered by a scattering element, such as a scattering plate 202, before reaching a Fabry Perot etalon 203. The transmission of the light by the etalon 203 can depend upon the wavelength and angle of incidence of the incoming light beam, according to an Airy function as is known in the art. After being transmitted from the etalon, the beam can create a concentric fringe pattern that is visible in the focal plane of the lens 204. The fringe pattern can be detected by a line scan camera 206. In place of a scattering element, a beam homogenizer 207 can be used to convert the non-uniform beam into a substantially homogeneous beam, as shown in FIG. 2(b). The homogenizer can have an appropriate residual divergence, such as on the order of at least 20 mrad. A system utilizing a beam homogenizer otherwise can operate in substantially the same way as a system utilizing a scattering element.

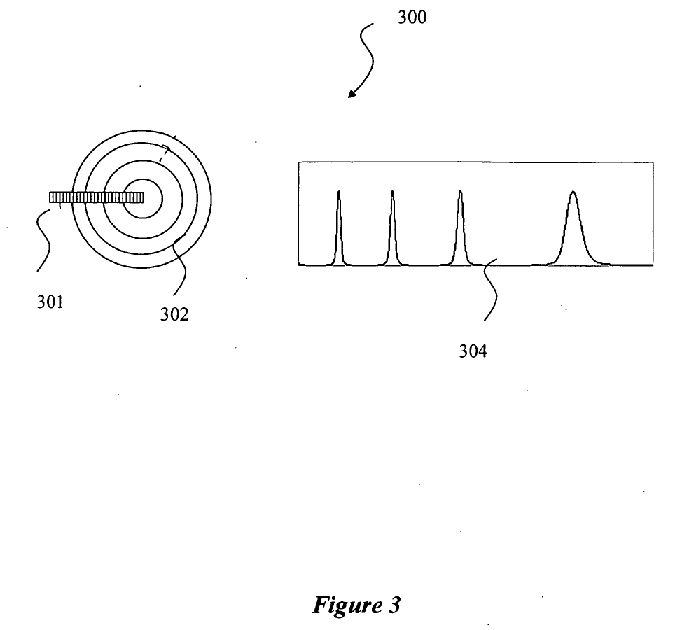

A closer view 300 of the detection of a fringe pattern is shown in FIG. 3. Here, the line scan camera 30′ is shown crossing each fringe 302 of the fringe pattern. As can be seen in the plot 304 on the right of FIG. 3, the line scan camera can detect the intensity of each fringe in the pattern, with each fringe representing a “peak” in the intensity pattern of the plot.

Each peak in the plot corresponds to an interference order. The smallest wavelength difference at which two wavelengths result in the same fringe pattern is called the free spectral range (FSR). The FSR for high resolving etalon-based spectrometers is relatively small in comparison to grating spectrometers. For an excimer laser, the FSR can be on the order of about 4 pm, such that a range of about ±2 pm can be used for the evaluation of one peak of the fringe pattern. The FSR of an etalon spectrometer can be determined with high accuracy, such that the peak positions of the measured fringe pattern can be used for wavelength scaling. A quadratic fit approach can be sufficiently accurate for the wavelength scaling of the measured fringe pattern. The wavelength can be calculated from the center pixel position of a peak, using the determined function λ=λ(pixel-number). The spectral width can be calculated from the peak width in pixels and the first derivation of the function λ=λ(pixel-number) at the current center pixel position of the peak.

When determining the spectral purity on-board using such a system, the “finesse” of the etalon can be important. The finesse is the ratio of the FSR to the FWHM of the system function of the spectrometer. The finesse of an etalon is presently limited to about 40, the limitation being due to factors such as residual non-conformities of the etalon plate surfaces. An etalon with a finesse of 40 is presently available from Coherent Inc. of Santa Clara, Calif. A typical finesse of 15, with a FSR of 4 pm, will have a system function width of 0.27 pm. The function width must be accounted for when measuring spectral bandwidths of less than 0.3 pm. The measurement error, which can result at least in part from the finite system function width of the on-board etalon spectrometer, can be compensated for by subtracting a fixed bandwidth offset. The bandwidth offset can be determined during the test of the monitor modules wherein the modules are compared with the external measured spectra. In certain embodiments, deconvolution can be a better approach than the use of a fixed offset. Further, the finesse of the etalon spectrometer can be increased to reduce the broadening of the measured spectra by the finite system function.

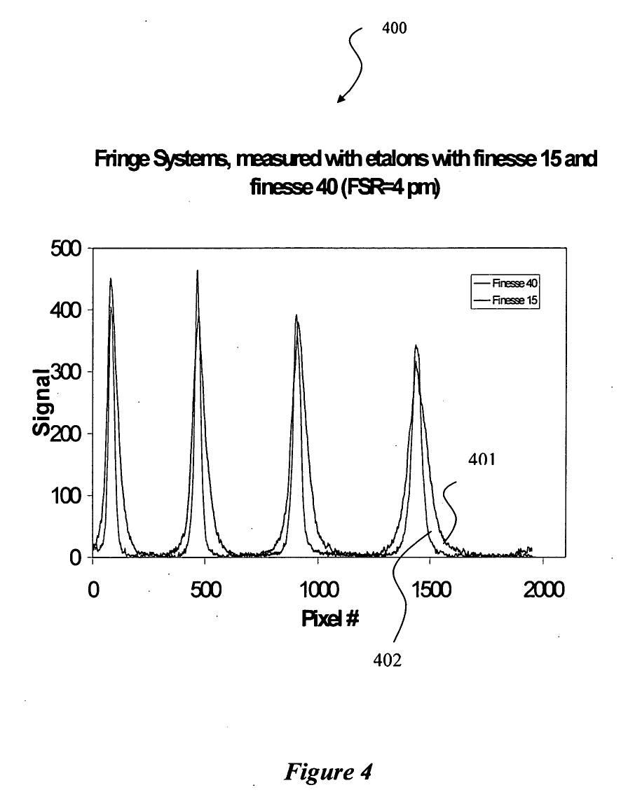

The desire for a higher finesse etalon can be addressed by using an etalon with a finesse of about 40 with the laser system. FIG. 4 shows a comparison of two fringe systems 401, 402, measured with an “old” finesse 15 etalon 401 and with a “new” finesse 40 etalon 402. The fringes measured with the F=40 etalon show a smaller FWHM, as well as a significantly smaller distribution in the feed region of the spectral peak. The smaller FWHM and feed region distribution can be important for performing an E95 calculation from these spectra. The FSR was the same for both measurements (4 pm) in this example.

In order to improve the signal-to-noise ratio of the camera detector to obtain useful E95 measurements, an improved line sensor can be used, such as is available from Hamamatsu, which has a signal to noise ratio that is approximately double that of previous sensors. The noise further can be reduced by filtering and/or smoothing the pixel values, such as over a three pixel range, before spectral evaluation. The signal-to-noise ratio also can be improved by cooling the chip of the camera detector or sensor.

Determination of E95 from Measured Fringe Systems

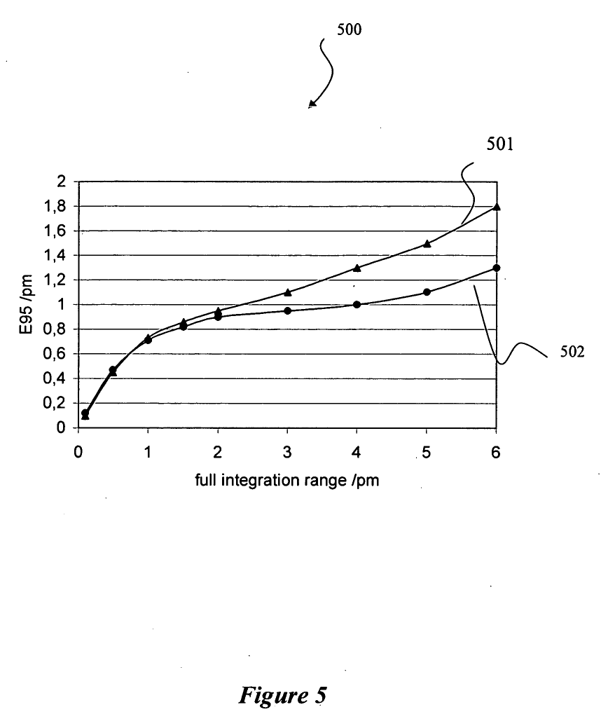

In order to obtain a sufficiently accurate calculation of spectral purity (E95), a range of ±5 pm can be used for the integration of a spectral distribution measured with the grating spectrometer. This large range cannot be applied on the etalon spectra due to the relatively small FSR of about 4 pm. The integration range theoretically is equal to, or smaller than, the FSR, such as on the order of ±2 pm. On the other hand, the same value has to be calculated independent of wavelength, such as from the peak position in the fringe system. As a result, a measured fringe system can be used to calculate E95 from the raw spectral data, which does not include corrections such as de-convolution or offset correction, using different integration ranges. An example of such an evaluation is shown in the plot 500 of FIG. 5. A curve 502 for a first peak shows a relatively ideal behavior of an E95 measurement curve, having a strong slope value in the range up to 2 pm (±1 pm), followed by a relatively small increase due to small signals outside of the ±1 pm range. The area of relatively small increase is followed by an increase in slope at around ±2 pm due to the influence of the neighboring peaks. A curve 501 for a second peak shows an increasing discrepancy at integration ranges larger than ±1 pm. The discrepancies in this region are due at least in part to the residual background, for which it can be extremely difficult to compensate.

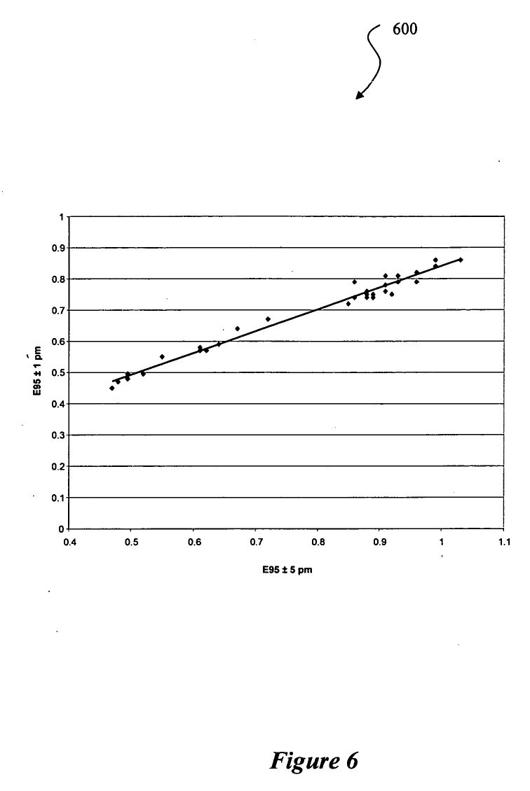

In order to determine the relationship between E95 values, calculations can be done using different integration ranges. An exemplary analysis utilized grating spectra of different lasers having different adjustment states. The E95 values that were obtained ranged from 0.5 to 1 pm, as shown in the plot 600 of FIG. 6. The resultant plot shows that a reduction of the integration range to about ±1 pm leads to values that are too small, but a linear relation can be obtained for the E95 values. Using this relationship, it is possible to calculate the values needed over the ±5 pm range, with an accuracy that is better than 0.05 pm.

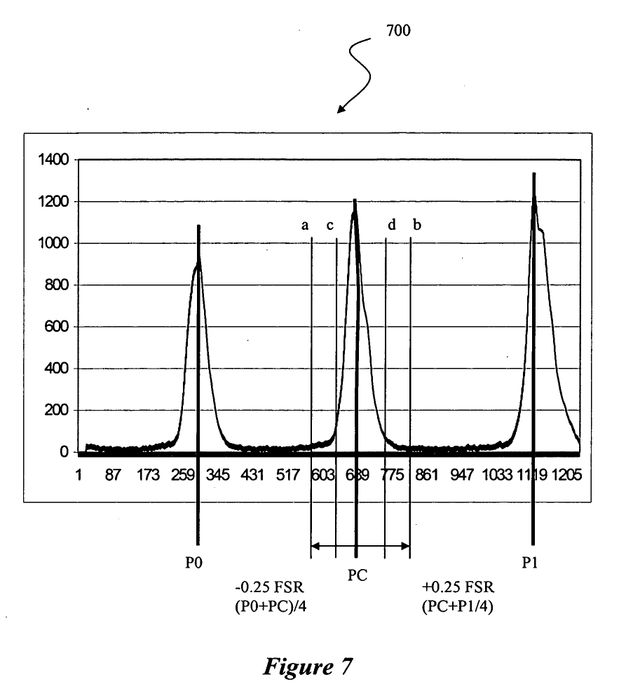

Once the necessary relationships are obtained in the pre-investigations, a calculation method such as the following can be introduced into the laser system through the appropriate system software. The calculation method will be described with respect to the plot 700 of FIG. 7. In an exemplary calculation method, the energy integral is calculated over the range of ±0.25 FSR around the center peak “Pc”, or “control peak.” In accordance with the exemplary system descriptions given above, this can translate into an integration range of +/−1 pm. The first interval limit can be calculated using the formula:

$$a = {P}_{C} - \frac{{P}_{C} - {P}_{0}}{4}$$

or, if P₀ is not present, calculated using the formula:

$$a = {P}_{C} - \frac{{P}_{1} - {P}_{C}}{4}$$

The second interval limit can be calculated using the formula:

$$b = {P}_{C} + \frac{{P}_{1} - {P}_{C}}{4}$$

or, if P₁ is not present, calculated using the formula:

$$b = {P}_{C} + \frac{{P}_{C} - {P}_{0}}{4}$$

The background can be calculated using the formula:

$$bg = \frac{\begin{matrix}pixel ( a - 1 ) + pixel ( a ) + pixel ( a + 1 ) + \\ pixel ( b - 1 ) + pixel ( b ) + pixel ( b + 1 )\end{matrix}}{6}$$

The energy integral can be calculated by summing the pixel values of the interval:

$$e = {\sum }_{i = a}^{b} pixel [ i ] - ( b - a + 1 ) * bg$$

The 95% of the energy integral then can be calculated by subtracting 2.5% on each integral limit. Starting from the limits a and b, the respective pixel positions of c and d for the 2.5% of the energy integral can be obtained, which are shown about the control peak in FIG. 7. E95 then can be calculated using the formula:

E95=d−c

The value of E95 will then have the unit of “pixels.” The E95 value can be transformed to a distance, such as with the units “pm,” using any pixel-to-distance conversion known in the art, such as using the first derivation of the function λ(pixel) at the position of the center peak, similar to the treatment of the FWHM. This distance value can be corrected by a factor and offset, in order to compensate for errors resulting from the small limited integration range and the residual width of the system function of the etalon spectrometer. This correction can be accomplished using the following formula:

E95=factor*E95_{measured}−offset

Experiments on different lasers with different monitor modules have shown that a factor of 1.4 can be used in general for monitor modules in accordance with one embodiment. This factor can be done during calibration, for example. Once the factor is obtained, only the offset need be determined. As discussed, the offset can be determined from comparison measurements with the external grating spectrometer, in the same way as for a determination of the bandwidth offset by performing a series of measurements in different operation conditions, or burst modes, of the laser.

Determining Process Accuracy

It can be desirable to further check the coincidence of spectral data E95 and bandwidth values measured with the on-board Monitor Module to values measured with an external grating spectrometer. The laser used for testing can be operated in different trigger modes, such as a continuous operation mode or one of a number of burst modes having differing repetition rates, in order to alter the change the spectral performance. These operation modes can be used to obtain relatively large fluctuations in spectral performance.

Instead of a de-convolution of the externally measured spectra, the measured bandwidth and spectral purity E95 values can be reduced using parameters that are typical for the spectrometer being used. The calibration of the on-board monitor module can be accomplished by adjusting an offset for the bandwidth and an offset for the E95 spectral bandwidth. The E95-factor, which can be used to correct the integration range reduction, can be set to 1.4 for reasons discussed above.

In an exemplary test of one system in accordance with embodiments of the present invention, the deviation in bandwidth was 0.090 pm (30%) peak to peak, with a Root Mean Square (RMS) error value of 0.030 pm (10%). The deviation of E95 was 0.070 pm (10%), with a Root Mean Square (RMS) error value of 0.017 pm (2.5%). The use of RMS values is well known in the art. These exemplary results show a good coincidence of the internally and externally measured data. The deviation in E95 is smaller than 0.05 pm for both measurements. The relative deviation of E95 values is significantly smaller than the relative deviations of bandwidth values.

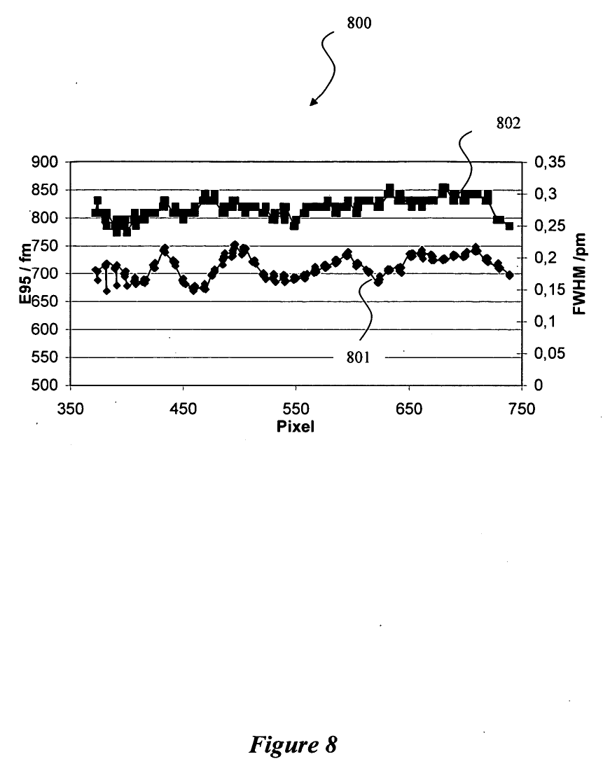

In order to determine the dependence of the spectral purity on wavelength, a wavelength shift test can be performed. FIG. 8 shows the results 800 from one such investigation, wherein the measured E95 801 and FWHM 802 are depicted for the center peak position. The shifts displayed in the plot were performed in a random order over a range of +10 pm. As can be seen, the spectral performance was nearly constant throughout the test. The residual structures in the curves are due in part to small in-homogeneities of the on-board monitor module. It can still be seen that the relative fluctuations in spectral purity are small in comparison to the FWHM values. The fluctuations can be estimated within a range of about ±0.05 pm, which corresponds to a relative error of about ±7.0%.

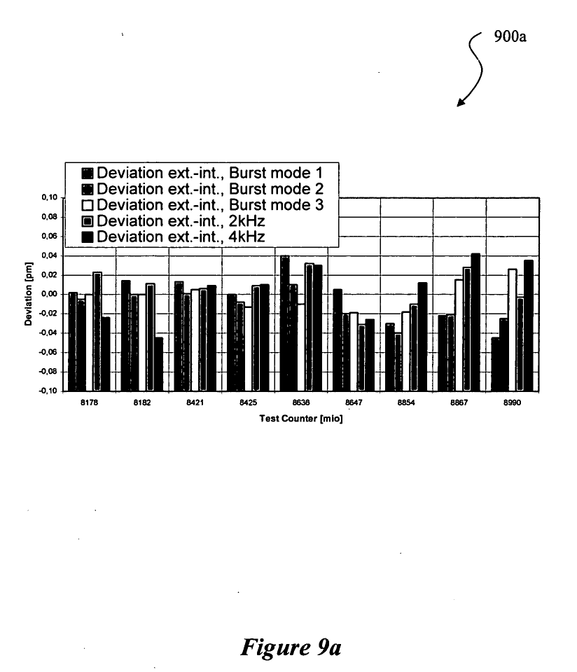

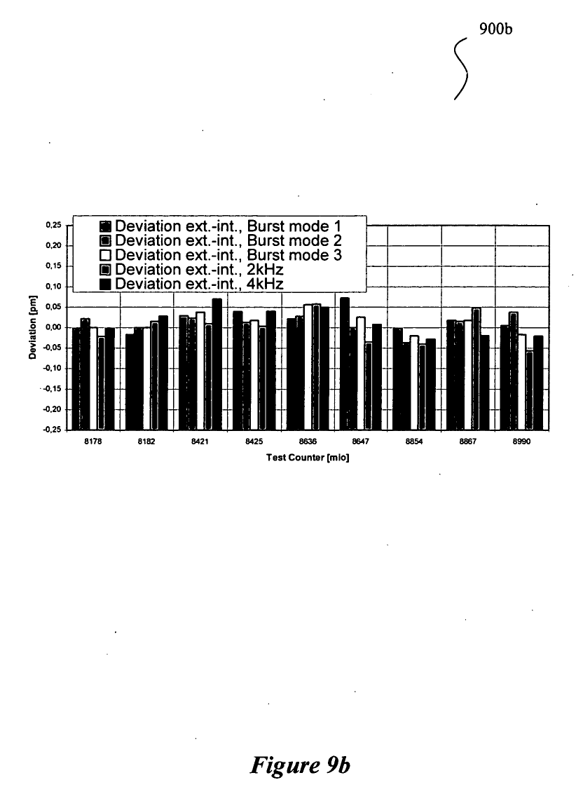

The stability of the described on-board E95 measurement was monitored in one experiment over nearly 1 billion pulses. FIG. 9a shows a graph 900a of the deviation between externally (grating spectrometer) and internally measured bandwidth. FIG. 9b shows a graph 900b of the deviation between externally (grating spectrometer) and internally measured E95 values. These values were measured at the given total pulse counter of the laser under different operation conditions, including different burst modes. The diagrams are scaled in such a way that a comparison of the relative deviation is possible. The diagrams show a good stability of the measured values, with no significant drift. Again, the relative deviations of the E95 measurements are smaller than the deviations of the bandwidth values.

Overall Laser System

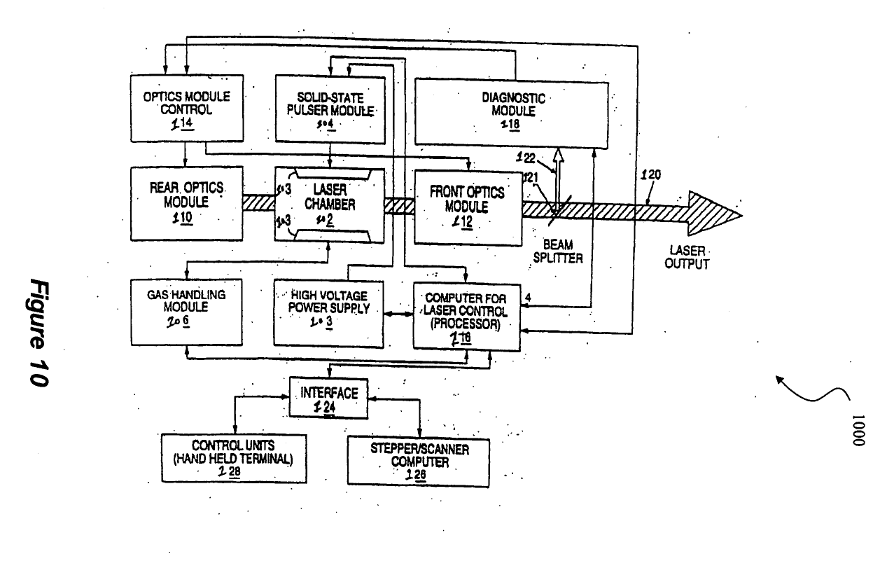

FIG. 10 schematically illustrates an exemplary excimer or molecular fluorine laser system 1000 that can be used in accordance with various embodiments of the present invention. The gas discharge laser system can be a deep ultraviolet (DUV) or vacuum ultraviolet (VUV) laser system, such as an excimer laser system, e.g., ArF, XeCl or KrF, or a molecular fluorine (F₂) laser system for use with a DUV or VUV lithography system. Alternative configurations for laser systems, for use in such other industrial applications as TFT annealing, photoablation and/or micromachining, e.g., include configurations understood by those skilled in the art as being similar to, and/or modified from, the system shown in FIG. 10 to meet the requirements of that application.

The laser system 1000 includes a laser chamber 1002 or laser tube, which can include a heat exchanger and fan for circulating a gas mixture within the chamber or tube. The chamber can include a plurality of electrodes 1004, such as a pair of main discharge electrodes and one or more preionization electrodes connected with a solid-state pulser module 1006. A gas handling module 1008 can have a valve connection to the laser chamber 1002, such that halogen, rare and buffer gases, and gas additive, can be injected or filled into the laser chamber, such as in premixed forms for ArF, XeCl and KrF excimer lasers, as well as halogen, buffer gases, and any gas additive for an F₂ laser. The gas handling module 1008 can be preferred when the laser system is used for microlithography applications, wherein very high energy stability is desired. A gas handling module can be optional for a laser system such as a high power XeCl laser. A solid-state pulser module 1006 can be used that is powered by a high voltage power supply 1010. Alternatively, a thyratron pulser module can be used. The laser chamber 1002 can be surrounded by optics modules 1012, 1014, forming a resonator. The optics modules 1012, 1014 can include a highly reflective resonator reflector in the rear optics module 1012, and a partially reflecting output coupling mirror in the front optics module 1014. This optics configuration can be preferred for a high power XeCl laser. The optics modules 1012, 1014 can be controlled by an optics control module 1016, or can be directly controlled by a computer or processor 1018, particularly when line-narrowing optics are included in one or both of the optics modules. Line-narrowing optics can be preferred for systems such as KrF, ArF or F₂ laser systems used for optical lithography.

The processor 1018 for laser control can receive various inputs and control various operating parameters of the system. A diagnostic module 1020 can receive and measure one or more parameters of a split off portion of the main beam 1022 via optics for deflecting a small portion of the beam toward the module 1020. These parameters can include pulse energy, average energy and/or power, and wavelength. The optics for deflecting a small portion of the beam can include a beam splitter module 1024. The beam 1022 can be laser output to an imaging system (not shown) and ultimately to a workpiece (also not shown), such as for lithographic applications, and can be output directly to an application process. Laser control computer 1018 can communicate through an interface 1026 with a stepper/scanner computer, other control units 1028, 1030, and/or other, external systems.

The processor or control computer 1016 can receive and process parameter values, such as may include the pulse shape, energy, ASE, energy stability, energy overshoot (for burst mode operation), wavelength, spectral purity, and/or bandwidth, as well as other input or output parameters of the laser system and/or output beam. The processor can receive signals corresponding to the wavefront compensation, such as values of the bandwidth, and can control wavefront compensation, performed by a wavefront compensation optic in a feedback loop, by sending signals to adjust the pressure(s) and/or curvature(s) of surfaces associated with the wavefront compensation optic. The processor 1016 also can control the line narrowing module to tune the wavelength, bandwidth, and/or spectral purity, and can control the power supply 1008 and pulser module 1004 to control the moving average pulse power or energy, such that the energy dose at points on a workpiece is stabilized around a desired value. The laser control computer 1016 also can control the gas handling module 1006, which can include gas supply valves connected to various gas sources.

The laser chamber 1002 can contain a laser gas mixture, and can include one or more preionization electrodes in addition to the pair of main discharge electrodes. The main electrodes can be similar to those described at U.S. Pat. No. 6,466,599 B1 (incorporated herein by reference above) for photolithographic applications, which can be configured for a XeCl laser when a narrow discharge width is not preferred.

The solid-state or thyratron pulser module 1006 and high voltage power supply 1010 can supply electrical energy in compressed electrical pulses to the preionization and main electrodes within the laser chamber 1002, in order to energize the gas mixture. The rear optics module 1012 can include line-narrowing optics for a line narrowed excimer or molecular fluorine laser as described above, which can be replaced by a high reflectivity mirror or the like in a laser system wherein either line-narrowing is not desired (XeCl laser for TFT annealing, e.g.), or if line narrowing is performed at the front optics module 1014, or a spectral filter external to the resonator is used, or if the line-narrowing optics are disposed in front of the HR mirror, for narrowing the bandwidth of the output beam.

The laser chamber 1002 can be sealed by windows transparent to the wavelengths of the emitted laser radiation 1022. The windows can be Brewster windows, or can be aligned at an angle, such as on the order of about 5°, to the optical path of the resonating beam. One of the windows can also serve to output couple the beam.

After a portion of the output beam 1022 passes the outcoupler of the front optics module 1014, that output portion can impinge upon a beam splitter module 1024 including optics for deflecting a portion of the beam to the diagnostic module 1020, or otherwise allowing a small portion of the outcoupled beam to reach the diagnostic module 1020, while a main beam portion is allowed to continue as the output beam 1020 of the laser system. The optics can include a beamsplitter or otherwise partially reflecting surface optic, as well as a mirror or beam splitter as a second reflecting optic. More than one beam splitter and/or HR mirror(s), and/or dichroic mirror(s) can be used to direct portions of the beam to components of the diagnostic module 1020. A holographic beam sampler, transmission grating, partially transmissive reflection diffraction grating, grism, prism or other refractive, dispersive and/or transmissive optic or optics can also be used to separate a small beam portion from the main beam 1022 for detection at the diagnostic module 1020, while allowing most of the main beam 1022 to reach an application process directly, via an imaging system or otherwise.

The output beam 1022 can be transmitted at the beam splitter module, while a reflected beam portion is directed at the diagnostic module 1020. Alternatively, the main beam 1022 can be reflected while a small portion is transmitted to a diagnostic module 1020. The portion of the outcoupled beam which continues past the beam splitter module can be the output beam 1022 of the laser, which can propagate toward an industrial or experimental application such as an imaging system and workpiece for photolithographic applications.

For a system such as a molecular fluorine laser system or ArF laser system, an enclosure (not shown) can be used to seal the beam path of the beam 1022 in order to keep the beam path free of photoabsorbing species. Smaller enclosures can seal the beam path between the chamber 1002 and the optics modules 1012 and 1014, as well as between the beam splitter 1024 and the diagnostic module 1020.

The diagnostic module 1020 can include at least one energy detector to measure the total energy of the beam portion that corresponds directly to the energy of the output beam 1022. An optical configuration such as an optical attenuator, plate, coating, or other optic can be formed on or near the detector or beam splitter module 1024, in order to control the intensity, spectral distribution, and/or other parameters of the radiation impinging upon the detector.

A wavelength and/or bandwidth detection component can be used with the diagnostic module 1020, the component including for example such as a monitor etalon or grating spectrometer. Other components of the diagnostic module can include a pulse shape detector or ASE detector, such as for gas control and/or output beam energy stabilization, or to monitor the amount of amplified spontaneous emission (ASE) within the beam, in order to ensure that the ASE remains below a predetermined level. There can also be a beam alignment monitor and/or beam profile monitor.

The processor or control computer 1018 can receive and process values for the pulse shape, energy, ASE, energy stability, energy overshoot for burst mode operation, wavelength, and spectral purity and/or bandwidth, as well as other input or output parameters of the laser system and output beam. The processor 1018 also can control the line narrowing module to tune the wavelength and/or bandwidth or spectral purity, and can control the power supply 1010 and pulser module 1006 to control the moving average pulse power or energy, such that the energy dose at points on the workpiece can be stabilized around a desired value. In addition, the computer 1018 can control the gas handling module 1008, which can include gas supply valves connected to various gas sources. Further functions of the processor 1018 can include providing overshoot control, stabilizing the energy, and/or monitoring energy input to the discharge.

The processor 1018 can communicate with the solid-state or thyratron pulser module 1006 and HV power supply 1010, separately or in combination, the gas handling module 1008, the optics modules 1012 and/or 1014, the diagnostic module 1020, and an interface 1026. The processor 1018 also can control an auxiliary volume, which can be connected to a vacuum pump (not shown) for releasing gases from the laser tube 1002 and for reducing a total pressure in the tube. The pressure in the tube can also be controlled by controlling the gas flow through the ports to and from the additional volume.

The laser gas mixture initially can be filled into the laser chamber 1002 in a process referred to herein as a “new fill”. In such procedure, the laser tube can be evacuated of laser gases and contaminants, and re-filled with an ideal gas composition of fresh gas. The gas composition for a very stable excimer or molecular fluorine laser can use helium or neon, or a mixture of helium and neon, as buffer gas(es), depending on the laser being used. The concentration of the fluorine in the gas mixture can range from 0.003% to 1.00%, in some embodiments is preferably around 0.1%. An additional gas additive, such as a rare gas or otherwise, can be added for increased energy stability, overshoot control, and/or as an attenuator. Specifically for a F₂-laser, an addition of xenon, krypton, and/or argon can be used. The concentration of xenon or argon in the mixture can range from about 0.0001% to about 0.1%. For an ArF-laser, an addition of xenon or krypton can be used, also having a concentration between about 0.0001% to about 0.1%. For the KrF laser, an addition of xenon or argon may be used also over the same concentration.

Halogen and rare gas injections, including micro-halogen injections of about 1-3 milliliters of halogen gas, mixed with about 20-60 milliliters of buffer gas, or a mixture of the halogen gas, the buffer gas, and a active rare gas, per injection for a total gas volume in the laser tube on the order of about 100 liters, for example. Total pressure adjustments and gas replacement procedures can be performed using the gas handling module, which can include a vacuum pump, a valve network, and one or more gas compartments. The gas handling module can receive gas via gas lines connected to gas containers, tanks, canisters, and/or bottles. A xenon gas supply can be included either internal or external to the laser system.

Total pressure adjustments in the form of releases of gases or reduction of the total pressure within the laser tube also can be performed. Total pressure adjustments can be followed by gas composition adjustments if necessary. Total pressure adjustments can also be performed after gas replenishment actions, and can be performed in combination with smaller adjustments of the driving voltage to the discharge than would be made if no pressure adjustments were performed in combination.

Gas replacement procedures can be performed, and can be referred to as partial, mini-, or macro-gas replacement operations, or partial new fill operations, depending on the amount of gas replaced. The amount of gas replaced can be anywhere from a few milliliters up to about 50 liters or more, but can be less than a new fill. As an example, the gas handling unit connected to the laser tube, either directly or through an additional valve assembly, such as may include a small compartment for regulating the amount of gas injected, can include a gas line for injecting a premix A including 1% F₂:99% Ne, and another gas line for injecting a premix B including 1% Kr:99% Ne, for a KrF laser. For an ArF laser, premix B can have Ar instead of Kr, and for a F₂ laser premix B may not be used. Thus, by injecting premix A and premix B into the tube via the valve assembly, the fluorine and krypton concentrations (for the KrF laser, e.g.) in the laser tube, respectively, can be replenished. A certain amount of gas can be released that corresponds to the amount that was injected. Additional gas lines and/or valves can be used to inject additional gas mixtures. New fills, partial and mini gas replacements, and gas injection procedures, such as enhanced and ordinary micro-halogen injections on the order of between 1 milliliter or less and 3-10 milliliters, and any and all other gas replenishment actions, can be initiated and controlled by the processor, which can control valve assemblies of the gas handling unit and the laser tube based on various input information in a feedback loop.

Line-narrowing features in accordance with various embodiments of a laser system can be used along with the wavefront compensating optic. For an F₂ laser, the optics can be used for selecting the primary line λ₁ from multiple lines around 157 nm. The optics can be used to provide additional line narrowing and/or to perform line-selection. The resonator can include optics for line-selection, as well as optics for line-narrowing of the selected line. Line-narrowing can be provided by controlling (i.e., reducing) the total pressure.

Exemplary line-narrowing optics contained in the rear optics module can include a beam expander, an optional interferometric device such as an etalon and a diffraction grating, which can produce a relatively high degree of dispersion, for a narrow band laser such as is used with a refractive or catadioptric optical lithography imaging system. As mentioned above, the front optics module can include line-narrowing optics as well.

Instead of having a retro-reflective grating in the rear optics module, the grating can be replaced with a highly reflective mirror. A lower degree of dispersion can be produced by a dispersive prism, or a beam expander and an interferometric device such as an etalon. A device having non-planar opposed plates can be used for line-selection and narrowing, or alternatively no line-narrowing or line-selection may be performed in the rear optics module. In the case of an all-reflective imaging system, the laser can be configured for semi-narrow band operation, such as may have an output beam linewidth in excess of 0.5 pm, depending on the characteristic broadband bandwidth of the laser. Additional line-narrowing of the selected line can then be avoided, instead being provided by optics or by a reduction in the total pressure in the laser tube.

For a semi-narrow band laser such as is used with an all-reflective imaging system, the grating can be replaced with a highly reflective mirror, and a lower degree of dispersion can be produced by a dispersive prism. A semi-narrow band laser would typically have an output beam linewidth in excess of 1 pm, and can be as high as 100 pm in some laser systems, depending on the characteristic broadband bandwidth of the laser.

The beam expander of the above exemplary line-narrowing optics of the rear optics module can include one or more prisms. The beam expander can include other beam expanding optics, such as a lens assembly or a converging/diverging lens pair. The grating or a highly reflective mirror can be rotatable so that the wavelengths reflected into the acceptance angle of the resonator can be selected or tuned. Alternatively, the grating, or other optic or optics, or the entire line-narrowing module, can be pressure tuned. The grating can be used both for dispersing the beam for achieving narrow bandwidths, as well as for retroreflecting the beam back toward the laser tube. Alternatively, a highly reflective mirror can be positioned after the grating, which can receive a reflection from the grating and reflect the beam back toward the grating in a Littman configuration. The grating can also be a transmission grating. One or more dispersive prisms can also be used, and more than one etalon can be used.

Depending on the type and extent of line-narrowing and/or selection and tuning that is desired, and the particular laser that the line-narrowing optics are to be installed into, there are many alternative optical configurations that can be used.

A front optics module can include an outcoupler for outcoupling the beam, such as a partially reflective resonator reflector. The beam can be otherwise outcoupled by an intra-resonator beam splitter or partially reflecting surface of another optical element, and the optics module could in this case include a highly reflective mirror. The optics control module can control the front and rear optics modules, such as by receiving and interpreting signals from the processor and initiating realignment or reconfiguration procedures.

The material used for any dispersive prisms, beam expander prisms, etalons or other interferometric devices, laser windows, and/or the outcoupler can be a material that is highly transparent at excimer or molecular fluorine laser wavelengths, such as 248 nm for the KrF laser, 193 nm for the ArF laser and 157 nm for the F₂ laser. The material can be capable of withstanding long-term exposure to ultraviolet light with minimal degradation effects. Examples of such materials can include CaF₂, MgF₂, BaF2, LiF, and SrF₂. In some cases fluorine-doped quartz can be used, while fused silica can be used for the KrF laser. Many optical surfaces, particularly those of the prisms, can have an anti-reflective coating, such as on one or more optical surfaces of an optic, in order to minimize reflection losses and prolong optic lifetime.

Various embodiments relate particularly to excimer and molecular fluorine laser systems configured for adjustment of an average pulse energy of an output beam, using gas handling procedures of the gas mixture in the laser tube. The halogen and the rare gas concentrations can be maintained constant during laser operation by gas replenishment actions for replenishing the amount of halogen, rare gas, and buffer gas in the laser tube for KrF and ArF excimer lasers, and halogen and buffer gas for molecular fluorine lasers, such that these gases can be maintained in a same predetermined ratio as are in the laser tube following a new fill procedure. In addition, gas injection actions such as μHIs can be advantageously modified into micro gas replacement procedures, such that the increase in energy of the output laser beam can be compensated by reducing the total pressure. In contrast, or alternatively, conventional laser systems can reduce the input driving voltage so that the energy of the output beam is at the predetermined desired energy. In this way, the driving voltage is maintained within a small range around HVₒₚₜ, while the gas procedure operates to replenish the gases and maintain the average pulse energy or energy dose, such as by controlling an output rate of change of the gas mixture or a rate of gas flow through the laser tube.

Further stabilization by increasing the average pulse energy during laser operation can be advantageously performed by increasing the total pressure of gas mixture in the laser tube up to Pₘₐₓ. Advantageously, the gas procedures set forth herein permit the laser system to operate within a very small range around HVₒₚₜ, while still achieving average pulse energy control and gas replenishment, and increasing the gas mixture lifetime or time between new fills.

A laser system having a discharge chamber or laser tube with a same gas mixture, total gas pressure, constant distance between the electrodes and constant rise time of the charge on laser peaking capacitors of the pulser module, can also have a constant breakdown voltage. The operation of the laser can have an optimal driving voltage HVₒₚₜ, at which the generation of a laser beam has a maximum efficiency and discharge stability.

Variations on embodiments described herein can be substantially as effective. For instance, the energy of the laser beam can be continuously maintained within a tolerance range around the desired energy by adjusting the input driving voltage. The input driving voltage can then be monitored. When the input driving voltage is above or below the optimal driving voltage HVₒₚₜ by a predetermined or calculated amount, a total pressure addition or release, respectively, can be performed to adjust the input driving voltage a desired amount, such as closer to HVₒₚₜ, or otherwise within a tolerance range of the input driving voltage. The total pressure addition or release can be of a predetermined amount of a calculated amount, such as described above. In this case, the desired change in input driving voltage can be determined to correspond to a change in energy, which would then be compensated by the calculated or predetermined amount of gas addition or release, such that similar calculation formulas may be used as described herein.

It should be recognized that a number of variations of the above-identified embodiments will be obvious to one of ordinary skill in the art in view of the foregoing description. Accordingly, the invention is not to be limited by those specific embodiments and methods of the present invention shown and described herein. Rather, the scope of the invention is to be defined by the following claims and their equivalents.

What is claimed is:

1. An on-board spectrometer for a narrow bandwidth laser, comprising:
a scattering element capable of scattering a beam of laser light incident upon the scattering element;
a high-finesse etalon positioned relative to the scattering element such that the etalon can create a fringe pattern from at least a portion of the scattered light beam; and
a detection element capable of detecting an intensity of the fringe pattern in order to determine a spectral purity of the laser light.

2. An on-board spectrometer according to claim 1, wherein:
the detection element is capable of detecting an intensity of the fringe pattern in order to determine an E95 spectral purity of the laser light.

3. An on-board spectrometer according to claim 1, wherein:
the high-finesse etalon is a Fabry Perot etalon.

4. An on-board spectrometer according to claim 1, wherein:
the high-finesse etalon has a finesse of at least 40.

5. An on-board spectrometer according to claim 1, wherein:
the high-finesse etalon has a finesse of at least 20 and a free spectral range of less than about 10 pm.

6. An on-board spectrometer according to claim 1, wherein:
the detection element is a line scan camera.

7. An on-board spectrometer according to claim 1, wherein:
the on-board spectrometer is capable of monitoring a spectral purity of the laser beam over the entire operation time of the narrow bandwidth laser.

8. An on-board spectrometer according to claim 1, wherein:
the etalon consists of two parallel surfaces.

9. An on-board spectrometer according to claim 1, wherein:
the etalon includes a confocal set-up having curved surfaces.

10. An on-board spectrometer according to claim 1, wherein:
the etalon is sealed and is capable of having a controlled pressure therein.

11. An on-board spectrometer according to claim 1, wherein:
the etalon is thermally stabilized with an accuracy of better than ±2 K.

12. An on-board spectrometer according to claim 1, wherein:
the on-board spectrometer is further capable of monitoring the FWHM characteristics of the laser.

13. An on-board spectrometer according to claim 1, wherein:
the on-board spectrometer has a footprint allowing the spectrometer to be used as an on-line module within the laser.

14. An on-board spectrometer according to claim 1, further comprising:
a processing module capable of receiving intensity data from the detection element and calculating a spectral purity of the laser light.

15. An on-board spectrometer according to claim 1, further comprising:
a grating spectrometer capable of determining a spectral purity of the laser light, such that a bandwidth offset of the etalon can be determined by comparing a spectral purity value measured by the etalon.

16. An on-board spectrometer according to claim 1, further comprising:
at least one lens positioned to focus the laser light on the scattering element.

17. An on-board diagnostic module for determining the spectral purity of a narrow bandwidth laser, comprising:
a scattering element capable of scattering a beam of laser light incident upon the scattering element;
a Fabry Perot etalon positioned relative to the scattering element such that the etalon can create a fringe pattern from at least a portion of the scattered light beam, the etalon having a finesse of at least 40;
a line scan camera capable of detecting the intensity of each fringe in the fringe pattern; and
a processor in communication with the line scan camera and capable of using information about the intensity to determine the spectral purity of the laser light.

18. An on-board diagnostic module according to claim 17, wherein:
the processor is capable of using information about the intensity to determine an E95 spectral purity of the laser light.

19. An on-board diagnostic module according to claim 17, wherein:
the processor is capable of subtracting an etalon offset from the intensity information in order to determine a spectral purity of the laser light.

20. A method for determining the spectral purity of a laser on-board, comprising:
scattering a beam of laser light emitted from a discharge chamber of the laser;
creating a fringe pattern from the scattered laser light using a high finesse etalon;
detecting the intensity of the fringe pattern using a high signal-to-noise detection element; and
determining a spectral purity of the laser light using information about the intensity of the fringe pattern.

21. A method according to claim 20, wherein:
determining a spectral purity includes determining an E95 spectral purity.

22. A method according to claim 20, further comprising:
generating a beam of laser light in the discharge chamber.

23. A method according to claim 20, further comprising:
directing a portion of the beam of laser light to a scattering element in a diagnostic module of the laser.

24. A method according to claim 20, further comprising:
measuring an offset of the high finesse etalon using a grating spectrometer.

25. A method according to claim 24, wherein:
determining the spectral purity includes subtracting the offset from the intensity detected by the etalon.

26. A narrow bandwidth laser system, comprising:
a resonator including therein a discharge chamber filled with a gas mixture, the discharge chamber containing a pair of electrodes connected to a first discharge circuit for energizing the gas mixture and generating a laser beam in the resonator, the discharge chamber further including at least one window for sealing the discharge chamber and transmitting the laser beam; and
a beam splitting element for redirecting a portion of the laser beam transmitted from the discharge chamber; and
a diagnostic module positioned within the laser system to receive the redirected beam portion, the diagnostic module including therein:
a scattering element capable of scattering the portion of the laser beam incident upon the scattering element;
a high-finesse etalon positioned relative to the scattering element such that the etalon can create a fringe pattern from the scattered laser beam portion; and
a detection element capable of detecting an intensity of the fringe pattern in order to determine a spectral purity of the laser beam.

27. An on-board spectrometer according to claim 26, wherein:
the detection element is capable of detecting an intensity of the fringe pattern in order to determine an E95 spectral purity of the laser light.

28. An on-board spectrometer according to claim 26, wherein:
the high-finesse etalon is a Fabry Perot etalon.

29. An on-board spectrometer according to claim 26, wherein:
the high-finesse etalon has a finesse of at least 40.

30. An on-board spectrometer according to claim 26, wherein:
the high-finesse etalon has a finesse of at least 20.

31. An on-board spectrometer according to claim 26, wherein:
the detection element is a line scan camera.

32. An on-board spectrometer for a narrow bandwidth laser, comprising:
a beam homogenizer capable of transmitting a beam of laser light incident upon the beam homogenizer, the beam homogenizer having a residual divergence of at least 20 mrad;
a high-finesse etalon positioned relative to the beam homogenizer such that the etalon can create a fringe pattern from at least a portion of the transmitted light beam; and
a detection element capable of detecting an intensity of the fringe pattern in order to determine a spectral purity of the laser light.

33. An on-board spectrometer according to claim 32, wherein:
the detection element is capable of detecting an intensity of the fringe pattern in order to determine an E95 spectral purity of the laser light.

34. An on-board spectrometer according to claim 32, wherein:
the high-finesse etalon is a Fabry Perot etalon.

35. An on-board spectrometer according to claim 32, wherein:
the high-finesse etalon has a finesse of at least 40.

36. An on-board spectrometer according to claim 32, wherein:
the high-finesse etalon has a finesse of at least 20 and a free spectral range of less than about 10 pm.

37. An on-board spectrometer according to claim 32, wherein:
the detection element is a line scan camera.

38. An on-board spectrometer according to claim 32, wherein:
the on-board spectrometer is further capable of monitoring the FWHM characteristics of the laser.

39. An on-board spectrometer according to claim 32, wherein:
the on-board spectrometer has a footprint allowing the spectrometer to be used as an on-line module within the laser.

40. An on-board spectrometer according to claim 32, further comprising:
a processing module capable of receiving intensity data from the detection element and calculating a spectral purity of the laser light.

41. An on-board spectrometer according to claim 32, further comprising:
a grating spectrometer capable of determining a spectral purity of the laser light, such that a bandwidth offset of the etalon can be determined by comparing a spectral purity value measured by the etalon.
